(19) United States
(12) Patent Application Publication
(10) Pub. No.: US 2019/0032904 A1
(43) Pub. Date: Jan. 31, 2019

(54) NOVEL TOUCH TYPE ELECTRONIC CANDLE LAMP

(71) Applicant: Ningbo Longsheng home decoration Co., Ltd., NINGBO (CN)

(72) Inventor: HAIBO WANG, NINGBO (CN)

(73) Assignee: Ningbo Longsheng home decoration Co., Ltd.

(21) Appl. No.: 15/668,692

(22) Filed: Aug. 3, 2017

(30) Foreign Application Priority Data
Jul. 31, 2017 (CN) 201720941534.3

(51) Int. Cl. F21V 23/04; F21S 9/02; F21V 17/10; F21S 6/00

(52) U.S. Cl. CPC F21V 23/0485; F21S 9/02; F21Y 2115/10; F21S 6/001; F21V 17/101

(57) ABSTRACT

The present invention relates to a novel touch type electronic candle lamp which comprises a light-transmitting waxen casing and a base embedded in the lower end face of the casing. The casing adheres to the base, a luminous body is installed in the casing, the upper end face of the casing is provided with a touch control piece for touching and switching on or switching off the luminous body; the touch control piece is connected with a touch chip; the base is provided with a battery compartment and a control key; the luminous body is connected with the touch chip, the battery compartment and the control key through a line, and the touch control piece is in a wick shape.

### CROSS-REFERENCE TO RELATED APPLICATIONS

This application claims priority to Chinese Patent Application No. 201720941534.3 with a filing date of Jul. 31, 2017. The content of the aforementioned application, including any intervening amendments thereto, are incorporated herein by reference.

### TECHNICAL FIELD

The present invention relates to the field of electronic candles, and in particular to a novel touch type electronic candle lamp.

### BACKGROUND OF THE PRESENT INVENTION

Since electronic candles emerged, the electronic candles are liked by more and more people due to their safety in use, convenience, energy saving and environmental friendliness, and particularly in European and American countries, the electronic candles gradually have the trend of replacing conventional fire rod candles. Some touch type electronic candles also appear on the market. However, the arrangement of touch control pieces of the touch type electronic candles makes the simulation degree of the electronic candles reduced greatly, and reduces the application range of the electronic candles.

### SUMMARY OF PRESENT INVENTION

Against the abovementioned current situation in the prior art, and against the technical problem to be solved, the present invention provides a novel touch type electronic candle lamp which is good in simulation and high in sensitivity.

The technical solution adopted to solve the aforementioned technical problem according to the present invention is a novel touch type electronic candle lamp comprising a light-transmitting waxen casing and a base embedded in the lower end face of the casing, wherein the casing adheres to the base, a luminous body is installed in the casing, the upper end face of the casing is provided with a touch control piece for touching and switching on or switching off the luminous body; the touch control piece is connected with a touch chip; the base is provided with a battery compartment and a control key; the luminous body is connected with the touch chip, the battery compartment and the control key through a line, and the touch control piece is in a wick shape.

Furthermore, the casing is a hollow columnar casing, and the center of the casing has a certain accommodating space to install the luminous body and a circuit board.

Furthermore, the touch control piece is a copper wire, the outer surface of the copper wire is sleeved with a rubber sleeve which imitates a candle wick having been burnt, so that the touch control piece fuses with the appearance of a candle, and the simulation is better.

Furthermore, the luminous body is a light-emitting diode (LED) lamp, saves more energy and is more environmentally friendly and long in service life.

Furthermore, the control key comprises a switching-on gear, a switching-off gear and a timing gear and can switch off a power supply when the power supply is unused, thereby being safe to use; in addition, the arranged timing gear makes the user experience more humanized, and an energy saving effect is achieved.

Furthermore, the thickness of the side wall of the casing is 0.5-2 cm, and the waxen casing is good in light transmission while the structural strength of the electronic candle lamp is guaranteed.

Compared with the prior art, the novel touch type electronic candle lamp according to the present invention has the advantages that the waxen casing is adopted, the luminous body is installed in the casing, and the upper end face of the casing is provided with the wick-shaped touch control piece, so that the electronic candle lamp is turned on or off through touch; the electronic candle lamp is simple in structure and high in simulation, a touch mode thereof is high in sensitivity and convenient to operate, and the electronic candle lamp is reasonable in design, conforms to market requirements and is suitable for popularization.

### DESCRIPTION OF THE DRAWINGS

FIG. 1 is a structural schematic view of the present invention; and

FIG. 2 is a section view of the present invention.

### DETAILED DESCRIPTION OF PREFERRED EMBODIMENTS

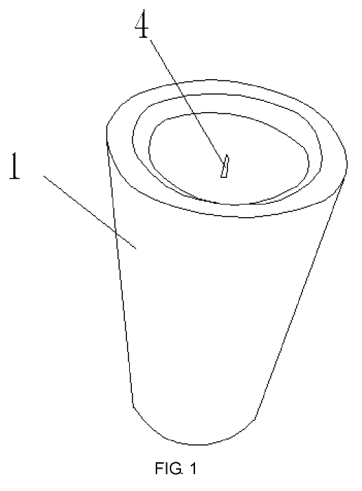

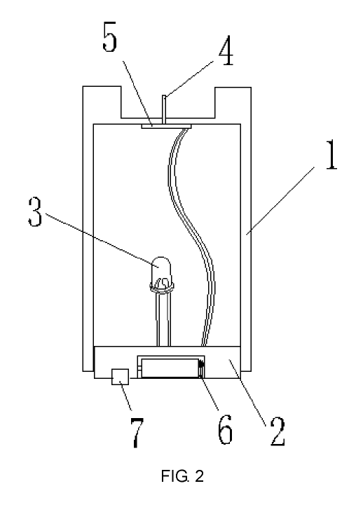

As shown in FIGS. 1 and 2, a novel touch type electronic candle lamp comprises a light-transmitting waxen casing 1 and a base 2 embedded in the lower end face of the casing 1; the casing 1 adheres to the base 2; the casing 1 is a hollow columnar casing, and the center of the casing 1 has a certain accommodating space; the thickness of the side wall of the casing 1 is 0.5-2 cm, and the waxen casing 1 is good in light transmission while the structural strength of the electronic candle lamp is guaranteed; a luminous body 3 is installed in the casing 1, is a light-emitting diode (LED) lamp, saves more energy and is more environmentally friendly and long in service life; the upper end face of the casing 1 is provided with a touch control piece 4 for touching and switching on or switching off the luminous body 3; the touch control piece 4 is connected with a touch chip 5; the base 2 is provided with a battery compartment 6 and a control key 7; an ordinary battery or a charging battery is installed in the battery compartment 6; the control key 7 comprises a switching-on gear, a switching-off gear and a timing gear; when the control key 7 is set to the switching-on gear, a user turns on or off the LED lamp through the touch control piece 4; when the control key 7 is set to the switching-off gear, a power supply can be switched off timely, thereby being safe to use; in addition, the arranged timing gear makes the user experience more humanized, and an energy saving effect is achieved; the luminous body 3 is connected with the touch chip 5, the battery compartment 6 and the control key 7 through a line, and the touch control piece 4 is in a wick shape; the touch control piece 4 is a copper wire, the outer surface of the copper wire is sleeved with a rubber sleeve which imitates a candle wick having been burnt, so that the touch control piece 4 fuses with the appearance of a candle, and the simulation is better.

According to the present invention, the waxen casing is adopted, the luminous body is installed in the casing, and the upper end face of the casing is provided with the wick-shaped touch control piece, so that the electronic candle lamp is turned on or off through touch; the electronic candle lamp is simple in structure and high in simulation, a touch mode thereof is high in sensitivity and convenient to operate, and the electronic candle lamp is reasonable in design, conforms to market requirements and is suitable for popularization.

I claim:

1. A novel touch type electronic candle lamp, comprising a light-transmitting waxen casing and a base embedded in the lower end face of the casing; the casing adheres to the base, a luminous body is installed in the casing, the upper end face of the casing is provided with a touch control piece for touching and switching on or switching off the luminous body; the touch control piece is connected with a touch chip; the base is provided with a battery compartment and a control key; the luminous body is connected with the touch chip, the battery compartment and the control key through a line, and the touch control piece is in a wick shape.

2. The novel touch type electronic candle lamp according to claim 1, wherein the casing is a hollow columnar casing.

3. The novel touch type electronic candle lamp according to claim 1, wherein the touch control piece is a copper wire, and the outer surface of the copper wire is sleeved with a rubber sleeve which imitates a candle wick having been burnt.

4. The novel touch type electronic candle lamp according to claim 1, wherein the luminous body is a light-emitting diode (LED) lamp.

5. The novel touch type electronic candle lamp according to claim 1, wherein the control key comprises a switching-on gear, a switching-off gear and a timing gear.

6. The novel touch type electronic candle lamp according to claim 1, wherein the thickness of the side wall of the casing is 0.5-2 cm.
